(19) United States
(12) Patent Application Publication
(10) Pub. No.: US 2004/0149170 A1
(43) Pub. Date: Aug. 5, 2004

(54) Cellular concrete having normal compressive strength

(76) Inventor: Osvaldo Moran, Miami, FL (US)

Correspondence Address: Patricia E. McQueeney, Becker & Poliakoff, P.A., 3111 Stirling Road, Fort Lauderdale, FL, 33312, US

(21) Appl. No.: 10/417,388

(22) Filed: Apr. 16, 2003

Related U.S. Application Data
(60) Provisional application No. 60/444,650, filed on Feb. 4, 2003.

(51) Int. Cl. C04B 16/08; C04B 20/00; C04B 38/00

(52) U.S. Cl. 106/672; 106/676; 106/677; 106/679; 106/681

(57) ABSTRACT

A method for producing hardened cellular concrete having normal compressive strength by producing tiny, unconnected, pre-pour, air-filled bubbles during mixing of cement, cementitious substitutes, sand, coarse aggregates, water, fiber, a surfactant, aluminum flakes or powder, calcium formate, and magnesium silico fluoride and then producing additional tiny, unconnected, post-pour, hydrogen-filled bubbles to replace those air-filled bubbles which are destroyed while pouring the fresh concrete during the casting operation. Only as much matrix is added to the coarse aggregate as is needed to engulf the aggregates while enabling the aggregate particles to be in contact.

### BACKGROUND OF THE INVENTION

(1) Field of the Invention

The present invention relates to a fiber reinforced lightweight high strength cellular concrete casting having a cured weight of under ninety pounds per cubic foot, made by the process of:

1) entraining air in a concrete slurry in the presence of a surfactant to form an aerated concrete slurry having a cementitious cellular structure;

2) casting the aerated concrete of step 1 in admixture with an in situ hydrogen—gas generating composition present in an amount such that hydrogen gas evolution during casting substantially maintains the cementitious cellular structure of the aerated concrete slurry produced in step 1 during the step of casting.

(2) Description of Related Art Including Information Disclosed Under 37 CFR 1.97 and 1.98.

Many U.S. patents for gas concrete, aero concrete, lightweight concrete, air-entrained concrete, and cellular concrete reveal problems with the stability of a cementitious foam and/or controlling the coalescing of small gas bubbles to form larger bubbles. In relation to the pouring or casting step, bubble formation can be classified into pre-foam methods, generally involving air entrainment to form bubbles in the presence of a surfactant, and post-foam methods, generally utilizing a powdered amphoteric metal, such as aluminum, zinc, lead, tin, and chromium to form hydrogen-filled bubbles. Aluminum is widely preferred.

U.S. Pat. No. 1,829,381 describes a combination of prefoaming and postfoaming, but postfoaming is accomplished by using a water-insoluble liquid having a boiling point below the boiling point of water, such as carbon tetrachloride, carbon disulphide, gasoline, benzol, and hexane. The cement mixture also contains a small amount of aluminum powder and is heated to a temperature of less than 100° C., whereby the aluminum reacts with an alkaline material in the cement to expand the mass to a small degree (prefoaming) and partially open the mix to accelerate evaporation of the volatile liquid (postfoaming) (page 1, lines 25-72).

In U.S. Pat. No. 2,236,988, the addition of Vinsol (a gasoline-insoluble resin) to a cement mix produces air bubbles of small size and uniform distribution while preventing coalescence of bubbles and stabilizing them in a pre-foaming method (page 2, left column, lines 9-54).

U.S. Pat. No. 2,560,871 describes a post-foaming method for making lightweight cement in which an aqueous bituminous emulsion, water, Portland cement, and aluminum flakes are violently mixed for 30 seconds. Then NaOH is added and violent mixing is resumed until “incipient gelation” begins, whereupon the mixture is poured into a mold (col. 2, lines 35-55 and col. 3, lines 1-32).

U.S. Pat. No. 4,135,940 teaches the incorporation of a colloid (hydroxypropylmethyl cellulose) in a concrete mix comprising equal parts by weight of fine sand and cement, lime, and an air entraining agent, whereby great proportions of air are entrained to obtain a controlled and pre-determined density (col. 2, lines 9-12 and col. 3, lines 9-20).

A postfoaming method is taught in U.S. Pat. No. 4,138,270, wherein aluminum flakes, a fatty acid alkanolamide, a nonionic surface active agent, and water are blended and kneaded to prepare an aqueous aluminum paste composition that has excellent long-term storage stability plus good dispersion in concrete mortar and remarkable bubble retention characteristics (col. 7, lines 27-32 and 44-68; col. 8, lines 1-7; and col. 9, lines 1-6). Although a surfactant is in the paste, it is not used for air entrainment.

As taught in U.S. Pat. No. 4,263,365, the foaming agent is preferably prefoamed before adding it to the mixing tank. Then 37% sodium silicate (water glass) is added to improve the stability of the mixture when poured and to improve bonding of the polypropylene fibers to each other (col. 5, lines 3-6).

In U.S. Pat. No. 4,624,711 (col. 3, lines 51-56), an “accelerator may be added to help prevent collapse of the surfactant foam, or conversely to induce sufficiently rapid hardening of the class C fly ash so that the surfactant foam does not have time to collapse before the agglomeration is formed.” This is a pre-foam process, the surfactant foam being “produced by the introduction of air under pressure into a liquid surfactant, preferably a sulfate surfactant” (col. 3, lines 43-45).

Controlling the viscosity of an air-entrained concrete slurry by heating the slurry and the mold so that viscosity is below critical for 30-45 seconds to enable a selected amount of fine bubble coalescence that is followed by rapid increase of viscosity, whereby settling of sand and larger particles may also be avoided, is described in U.S. Pat. No. 5,775,047, cols. 5 and 6 and as illustrated in FIG. 2.

U.S. Pat. No. 5,996,693 teaches the use of an oil based drilling fluid comprising Portland cement, sufficient water to form a pumpable slurry, aluminum powder for in situ foam generation, and a water-wetting foam stabilizing surfactant (preferably sodium alkylpolyether sulfonate) for pumping into the annulus of a deep, high-temperature well bore containing a string of pipe. The surfactant and the aluminum act simultaneously, and the surfactant has no air entraining function.

Controlling problems involving expansion or destruction of bubbles during the pouring or casting step by viscosity control of the cement or concrete slurry, with or without heating, involves difficult and expensive steps. It is desirable to utilize a simpler method that can produce a strong, cellular concrete.

It has been found that when pouring a pre-foam cellular or lightweight concrete into molds, the force of the mix being poured destroys many of the bubbles, whereby the end product weighs more than it ideally should. A method for achieving an ideal density is accordingly needed.

It is also desirable to provide a method for accurately estimating the amount of slurry, comprising water, cement, fiber, surfactant, and aluminum flakes, to be added to a specific aggregate mixture whereby the aggregate particles touch one another and are unable either to float or to sink within the mold.

### SUMMARY OF THE INVENTION

It is an object of this invention to provide a sequential bubble-forming method that requires no heating or viscosity-increasing steps for ensuring adequate bubble formation and retention during the pouring and casting of a concrete slurry for producing cellular concrete.

It is another object to provide a method for producing a cellular concrete, in which a portion of the bubbles produced by air entrainment with a selected surfactant (pre-foam) are lost during the pouring and casting step, are replaced by post-foam generation of hydrogen-filled bubbles.

It is an additional object to provide a cellular concrete having “post-cracking strength” by admixture of a fiber, such as polypropylene fiber.

It is a further object to provide a cellular concrete having normal compressive strength by admixture of calcium formate and magnesium silico fluoride.

It is a still further object to provide a cellular concrete having normal compressive strength by admixture of selected amounts of substitute cementitious materials, such as finely-ground pozzolanic material. Pozzolanic material as used herein is defined in the art, e.g., as defined in U.S. Pat. No. 3,177,281 and ASTM C219 define pozzolan as a finely divided material rich in silica, alumina or both which in itself possesses little or no cementitious value that will react with hydrated lime at ordinary temperatures in the presence of moisture to form compounds possessing cementitious properties. Pozzolans include, but are not limited to: silica flour, ground silica sand, burned oil-shale, fly ash, grcaad brick or tile, volcanic ash, volcanic glass, granulated slag, blast-furnace slag, diatomaceous earth, pumice dust, or glass grinding waste. See, Maurice Pattengill and T. C. Shutt, Use of Ground Glass as a Pozzolan, Presented at the Albuquerque Symposium on Utilization of Waste Glass in Secondary Products, Jan. 25-25, 1973.

It is a final object to provide a cellular concrete having a density within the range of 45 to 100 pounds per cubic foot and normal compressive strength by admixture of a selected amount of aggregates, such as fine sand and lightweight materials such as expanded shale, expanded clay or pumice.

In accordance with these objects and thee principles of this invention, the essential components, specifically, cement, surfactant and water, are mixed with sand and lightweight aggregates to form a mixture, containing air bubbles caused by mixing, that is satisfactory for forming cellular concrete if pouring and casting are not needed. However, in nearly all practical situations, transfer from a mixing vessel to a mold is required. Such transfer inevitably destroys some of the air-containing bubbles. To replace the air bubbles destroyed in the pouring process with post-pour, hydrogen-filled bubbles, it is necessary to add to the mixture a relatively small quantity of aluminum flakes after the mixture has been transferred to a mold.

The fiber-reinforced, high-strength, cellular concrete of the invention weighs from about 45 to about 100 pounds per cubic foot, compared to regular concrete at 160 pounds per cubic foot and lightweight concrete at 120 pounds per cubic foot, and has the same compressive strength (about 4,000 psi) as regular concrete. The weight of this cellular concrete ranges from about 30% of the weight of regular concrete to about 80% of the weight of lightweight concrete. This weight/strength relationship makes the construction of a large structure much less expensive and demanding as the height of the structure is increased. The cellular concrete of this invention is particularly useful for floors.

A matrix is a mixture of Portland cement, pozzolans, water, and air together with additives. Although the sequence of addition of concrete components may be varied, originally it is preferred that all the additives are combined in dry form and added to the water; next aggregates are poured in the mix, then, cement and lastly the fibers.

Such a matrix is commonly referred to as a concrete slurry or a paste. Aggregates are a mixture of coarse, medium and fine non-reactive particles, preferably graded according to ASTM-C33. Fresh concrete is formed by admixture of aggregates and fiber with the matrix. The fresh concrete is poured into a mold which may contain some reinforcement elements. This pouring operation is defined as casting.

The amount of air that will be lost during casting depends on casting method, product design, mix design, and tortuosity of the pour. Loss of air can be estimated by simulating the casting process and measuring product density before and after the simulation. Simulation can be achieved by dropping the matrix a distance and through obstacles that are both representative of the reinforcement process.

The amount of aluminum flakes to be added is calculated in proportion to the amount of air expected to be lost during casting. For example, if 30% of the air volume in the surfactant-sustained bubbles is lost during casting, enough aluminum must be introduced in order to evolve enough hydrogen-filled bubbles to regenerate that lost 30%. Aluminum flakes should consequently be added at the rate of approximately 0.0003 pounds per cubic foot of matrix in order to add hydrogen-filled bubbles equal to 1% of the volume of the matrix. In this example, if the total volume of matrix is 500 cubic feet, 0.15 pounds of aluminum must be added, such addition preferably is made just before pouring begins.

The rate of reaction of the aluminum with an alkaline material in the cement to evolve hydrogen gas is dependent on the surface area of the aluminum and amount of stearic coating that is put on the aluminum. In general, the desirable speed of reaction depends on the casting process. It is also pertinent that a variety of aluminum powders are on the market that will react at different times, according to particle size, shape, and stearic coating. These variable characteristics allow an operator to choose the aluminum flakes or powder that will begin to react exactly when needed.

Fiber is another ingredient that may be included in the cellular concrete of the present invention. The use of a fiber compound increases the flexural strength of the concrete and reduces surface cracks. Euclid Chemical Co sells a polypropylene fiber suitable for use in cellular cementitious mixes under the trademark Fiberstrand 100. Moreover, if an earthquake or an explosion causes product failure, the fiber in the product holds it together and prevents total collapse. This quality is referred to as “post-cracking strength.” Typical concrete, unless reinforced, has no post-cracking strength.

Anionic, nonionic, and cationic surfactants can be used, but anionic surfactants are most satisfactory. Although cationic surfactants may be used, they are not necessarily used to the same effect; and accordingly they are not as desirable for use in the present invention.

The preferred surfactant is dodecyl benzenesulfonic acid salt (DBS), an anionic surfactant. The surfactant enables the tiny, disconnected pre-pour air bubbles created during the mixing process to stay in the matrix without escaping. The surfactant also stabilizes all bubbles, including the post-pour hydrogen-filled bubbles evolved by the reaction of aluminum with hydroxides. Also, the surfactant is the agent that permits the total amount of aluminum to be reduced.

The sequential use of surfactant and aluminum powder is effective with all types of Portland cement, regardless of fineness. Aluminum is the least desirable compound to use with sulfo-aluminate cements. The calcium hydroxide concentrations in sulfo-aluminate cements are typically too low to evolve sufficient hydrogen gas in a reaction with aluminum to generate and maintain the cementitious cellular structure of the aerated concrete slurry. Minor adjustments to amounts may be necessary, but the preferred cements are Portland cement types I, II, and III, depending on the setting speed that is desired.

Fineness of concrete components, including cement, cement substitutes, and aggregates, has a strong effect on water demand: the finer the particles, the less water is needed. Finer particles tend to be more reactive and create a harder product. Further, the gradation curve of the total volume of particles in the matrix strongly affects workability and, therefore, water demand. Fineness of cement and cement substitutes also affect reactivity and must be controlled. For example, ground pozzolanic material should preferably pass a 200-mesh sieve and most preferably a 325-mesh sieve. Pozzolanic materials, such as fly ash and silica fume, are adequately fine.

### DETAILED DESCRIPTION OF THE INVENTION

Any natural or synthetic fiber of adequate strength, such as small-diameter polypropylene fibers, can be used. Any suitable fiber provides many benefits, including the following:

a. In the mixing process, the addition of fibers significantly helps to stabilize the formation of air bubbles and to retain the bubbles in suspension after formation thereof. For example, adding a fiber content of 1% was found to reduce the final density of one mix from 80 pounds per cubic foot (“pcf”) to 65 pcf.

b. The presence of fiber delays surface cracking as well as other types of cracking and improves post-cracking strength.

c. The presence of fiber significantly increases both post crushing strength and energy absorption. These benefits increase as concrete density decreases.

d. Fiber content has been found to increase compressive strength slightly. For example, an 80 pcf mix without fiber failed at 2200 psi while an otherwise identical mix with 1% fiber failed at 2300 psi.

e. Fiber content increases fatigue and freeze-thaw strengths.

The most preferred mixtures are as follows:

a. Cementitious materials: 26%-27% by weight of the total mixture is cement or a substitute, such as fly ash or slag, and finely ground pozzolanic material. Such substitutes can be present in an amount as high as 70%-90% by weight of the cement.

b. Aggregates: Approximately 11% by weight of the total mixture is most preferably fine sand, and about 52% of the total mixture by weight is most preferably coarse material such as expanded shale, expanded clay, pumice, or other suitable lightweight aggregate materials.

c. Water: Water is about 10.5% by weight of the total mixture.

d. Additives, pre-mixed in powder form, as pounds per cubic foot of final product:

1) surfactant: about 0.04;

2) aluminum flakes or powder: about 0.01;

3) calcium formate: about 0.06; and

4) magnesium silico fluoride: about 0.006.

e. Fiber: about 1%.

In the most preferred embodiment of the invention, all the additives are combined as dry powder and added to the water; then aggregates are poured into the mix, followed by cementitious materials and lastly by the fibers. Mixing time is about 3-4 minutes and produces the needed amount of air-filled bubbles by entrainment. However, a counter-rotating mixing machine or a high-speed mixing machine can reduce the mixing time. Another aspect of the present invention relates to use and calculation of the amount of matrix or paste which is combined with the aggregate. Matrix or paste is finer-reinforced cellular concrete without the fine and coarse aggregates. The following steps show a preferred method for calculating the amount of matrix or paste to add to fine and coarse aggregates whereby the aggregates will be in contact with and be surrounded by the matrix according to the minimum matrix concept of this invention:

1) provide a mold that measures exactly one cubic foot;

2) fill the mold to the top with the desired amounts of fine and coarse aggregates, gently compact the aggregates, and add sufficient aggregates to coincide with the top of the mold;

3) fill the mold to overflowing with water and wait for the porous aggregates to be saturated with water (a wait of three to four minutes typically suffices), and add additional water to overflow the mold;

4) remove the water from the mold and measure its amount;

5) add the same amount of the matrix or paste to the aggregates in the mold, thereby forming fresh concrete; and

6) subject the fresh concrete in the mold to vibration and then add additional matrix so that the mold is exactly filled.

As will be appreciated, the volume specified, one cubic foot, is a convenient measurement and a measurement suitable and used in the United States. The unite of measurement can be, of course, any suitable measurement of volume.

Generally, fly ash derived from different coal varies in chemical composition. Typically, however, the fly ash of the different coal varieties have principal components in common: SiO₂ (25% to 60%), Al₂O₃ (10% to 30%), and Fe₂O₃ (5% to 25%) The MgO content of fly ash moreover is generally not greater than 5%. Thus, the term fly ash generally refers to solid powders comprising from about 25% to about 60% silica, from about 10% to about 30% Al₂O₃, from about 5% to about 25% Fe₂O₃, from about 0% to about 20% CaO, and from about 0% to about 5% MgO.

Fly ash is a by-product of coal usage in power plants and is known to be composed of many fine ash particles ranging in size from about 1 to 100 microns. Coal-burning electric power plants that burn subbituminous coal produce subbituminous fly ash. This particular fly ash is high in calcium oxide and is included in the ASTM designation 0618 as a Class C fly ash. The volume of subbituminous material available is increasing rapidly because it has the lowest emission rating of all the coals that are burned.

Calcium, from calcium formate, and magnesium, from magnesium silico fluoride, produce high early strength. High early strength is needed to obtain the cellular structural concrete of the invention. Such cellular structural concrete is approximately 60% of the weight of conventional concrete and is useful for building large structures requiring great strength. Other accelerators and hardeners known in the trade can replace calcium and magnesium.

As previously described, pozzolanic components include fly ash, bottom slag and coal ash. Where high-carbon fly ash is used, the amount of aluminum additive required is greater than needed to generate more bubbles.

Most of the lightweight aggregates are very porous. Every lightweight aggregate has a different absorption ratio that is a function of the void structure within the aggregate. This absorption ratio is usually between 20% and 30% by weight, although more extreme variations are easy to find.

It is a well-known fact that fly ash reduces the required water content in concrete and consequently increases the final compressive strength of the concrete. Concrete in which the cement has been partially replaced with fly ash develops strength more slowly than concrete without fly ash. Because fly ash is lighter than cement, partial replacement of cement with fly ash reduces concrete density. Both compressive strength and modulus of elasticity increase with density, but the: relationships depend on the aggregates used and the mix design.

Because the lightweight materials are hygroscopic, it is important that they be moist before they are added to the final matrix. If dry, they will absorb water from the matrix; working with a matrix that lacks the proper amount of water is difficult. Further, the cementitious material will lack the necessary water for proper hydration during the first critical hours. However, if the water-to-cement ratio is correct and if the aggregates have the necessary moisture, this moisture will stay within the mass and will be released slowly while the whole mass crystallizes (especially during the first 56 days), thereby allowing more cementitious material to harden to an ideal state. Ideally-hydrated concrete has higher strength and longer life and is less likely to crack than concrete that has either too much or too little hydration.

The ideal matrix is defined as the actual fiber reinforced cellular cement matrix without the aggregates that will produce the strongest product. After selecting the ideal matrix, every component thereof needed to manufacture a determined amount of matrix without fine or coarse aggregates can be calculated. This amount can be determined by compacting the desired aggregate mix within a container of known volume and, exactly to the top thereof, adding water thereto, allowing the water a few minutes to displace voids, adding more water to fill the container exactly to the top thereof, draining off the water, and measuring the drained water. This measurement is the amount of matrix without fine, medium and coarse aggregates to be added to the desired aggregate mix.

A mass of concrete tends to shrink as water evaporates during the hardening or curing of the mass of concrete. Shrinking causes stress shown by cracks in the mass of concrete. Two methods are known in the art for reducing such shrinkage.

One method is to add “expansive” admixtures to the concrete mixture, thus creating an opposite force to the shrinking force; commercially available products that work well are Eclipse and Eclipse Plus.

The other method of reducing such shrinkage is to add substances to reduce the capillary tension of pore water in the concrete mass. Master Builders manufactures Tetraguard AS 20, an admixture that helps to reduce cracks in a concrete mass by reducing the capillary tension of pore water in the concrete mass.

All of these additives improve the quality of a cellular concrete, particularly if the concrete has the ideal ratios of coarse, medium and fine aggregates.

An additional method for reducing shrinkage is to add a superplasticizer that reduces the amount of water in the concrete mixture, because most cracking occurs as water evaporates while the concrete hardens. A concrete mixture produced with less water will have less tendency to crack while hardening.

Metals or plastics can be reinforcement material. Suitable reinforcement metals are iron rebars, steel forms, galvanized metal “V”s, and aluminum forms. Satisfactory reinforcement plastics are carbon-based, silicone-based, and polypropylene.

Ambient temperature is satisfactory for preparing the fresh concrete of this invention; generally speaking, temperature makes little difference in the final product.

pH of the concrete mass is irrelevant to the final product.

Lightweight concrete can be of benefit for high-rise buildings and particularly for floor slabs. The fiber-reinforced, high-strength, cellular concrete of the invention, weighing about 75 pcf to about 100 pcf, is more fire resistant than liqhtweiqht concrete, weiqhinq approximately 120 pcf; and lightweight concrete is more fire resistant than regular concrete weighing approximately 160 pcf. It is unnecessary to increase the thickness of the concrete slab to gain the benefit of the increased fire resistance of cellular concrete. The decreased weight and increased fire resistance reduces the costs of columns and foundation. However, architects must bear in mind that lightweight concrete is more flexible than normal weight concrete, so, that the deflection and vibration of floor slabs could be expected to increase.

The minimum matrix concept of this invention is defined as an optimum value of the volume ratio of cementitious matrix to hard aggregate. Specifically, if coarse and fine aggregates are placed in a container with no matrix and are compacted as much as possible without crushing the aggregates, the air between the aggregates is defined as voids. If matrix is then added, the volume of voids is reduced. If just enough matrix is added, the volume of voids is reduced approximately to zero. The ratio of matrix volume to aggregate volume that is required to reduce void volume to zero is called the “Minimum Matrix Ratio.”

Adding additional matrix serves to separate the aggregates, and make the concrete lighter.

A characteristic of cellular concrete made from matrix-rich mixes is high values of shrinkage and moisture movement, caused by the relatively high cement content of these cellular concretes.

Aggregates help to reduce shrinkage for two reasons. First, they are vitreous and therefore do not shrink from loss of water. Second, they restrain the shrinkage of the matrix around them.

It is therefore possible to have a matrix-rich mix with just enough aggregate to reduce shrinkage but not enough aggregate to exceed the target density. However, the benefit of aggregate with respect to controlling shrinkage is not as great as it is with the minimum matrix ratio.

Increasing the air/matrix ratio decreases the tensile and compressive strengths of the matrix. As the air/matrix ratio increases, the failure mode changes from “crack through aggregate” to “crack around aggregate” and eventually to “crack entirely through matrix.” The path of the crack formation significantly affects the strength of the concrete. Crack through aggregate results in high strength, whereas crack entirely through matrix results in low strength.

Increasing the air/matrix ratio obviously reduces concrete density. The optimum mix design for a target density and strength may use the minimum matrix ratio with the matrix containing much air. In contrast, the same density may be achieved with a slightly matrix-rich ratio and somewhat less air in the matrix, thereby also yielding higher strength.

Cast-In-Place (CIP) applications for cellular concrete have the tremendous benefit of savings in transportation costs associated with moving precast concrete from factory to jobsite. It also allows the concrete to take the form of whatever the jobsite may require. The use of cellular concrete in this method is made possible by incorporating surfactant in the mix so that the revolving drum on the concrete delivery truck acts as an air-entrainer to generate air bubbles.

Once on the jobsite, and just minutes before pouring, the appropriate amount of aluminum is added to the mix. The entire volume of concrete in the truck must be discharged at the same time in order to avoid having the aluminum reaction occur within the mixer. However, partial discharge at any one jobsite is feasible if an aluminum dispenser is installed in the discharge chute of the truck.

Variations of this basic mix can produce a large array of products, depending on the strength as well as the weight of the concrete that is desired.

### EXAMPLE 1

A 16-cubic-feet on-site mixer, operated by six men and a foreman, is stationed on a concrete wheel bed within about 25 feet of the edge of a warehouse floor to be poured. The mixer's discharge chute is directed toward the job, and its skip is lowered onto the concrete skip bed. The sand pile, the coarse aggregate pile, the fly ash pile, and the cement platform are disposed around a dump block, adjacent to the skip, on which is located a platform scale having wheelbarrow runways on opposite sides thereof. A hose is available to supply water to the mixer.

While a 3-cubic-feet wheelbarrow is on the scale, one man opens one 94-pound Portland III cement bag and empties its contents (30% of the cementitious mixture; 7.8% of the total mixture) into it. With the first man's help, another man shovels 133 pounds of sand (11% of the total mixture) into the wheelbarrow, dumps its contents into the skip, and returns it to the scale. They continue by shoveling 219 pounds of fly ash (as 70% of the cementitious mixture; 18.2% of the total mixture) into the wheelbarrow in successive loads, dump them into the skip, and return the wheelbarrow to the scale. In successive loads, they shovel 627 pounds of expanded shale, coarse aggregate, into the wheelbarrow, dump the aggregate into the skip, and return the wheelbarrow to the scale (52% of the total mixture). One of the men finally empties four bags, previously weighed, which contain 0.48 pound of dodecylbenzene sulfonate, 0.12 pound of aluminum flakes, 0.72 pound of calcium formate, and 0.07 pound of magnesium silico fluoride directly into the skip.

The contents of the mixer now weigh 1,074.39 pounds, all substantially dry. Using a small barrel which is mounted on the mixer and marked in gallons, one man adds 15.24 gallons of water, equaling 127 pounds (as 10.5% of the total mixture), so that the total weight in the mixer is now 1,201.39 pounds. Lastly, 12 pounds of polypropylene fibers are added to the skip. The final weight of the contents of the mixer is 1,213.39 pounds. The mixer is started and runs for 5 minutes. The fresh concrete then flows down the discharge chute into successive wheelbarrows handled by the six men who move them onto main double ramps, as sections are placed and side ramps are removed, while the foreman carefully watches the operation.

### EXAMPLE 2

A transit mixer, identified as a Mack truck, having a standard load of 8 cubic yards, a maximum load of about 10 cubic yards, and a minimum delivery of about 4 cubic yards, is available when a rush telephone call comes from a customer for immediate delivery of 8 cubic yards of fresh concrete containing sufficient air bubbles to produce hardened concrete having a density of about 80 pounds per cubic foot (pcf) and a compressive strength of about 4,000 pounds per square inch (psi) after 28 days.

A quick calculation shows that 17,280 pounds of total mixture, to produce the required fresh concrete, will be needed. Utilizing every man available and all forklift trucks and powered wheelbarrows, the transit mixer is filled in record time with 3,370 pounds of finely ground pozzalanic material (as 75% of the cementitious materials), 12 bags of Portland type I cement (as 25% of the cementitious materials which equal 26% of the total mixture), 1,901 pounds of fine sand (as 11% of the total mixture), 8,986 pounds of coarse aggregate (as 52% of the total mixture), 173 pounds of polypropylene fiber, and the following quantities of additives:

6.91 pounds of dodecylbenzene sulfonate:

1.73 pounds of aluminum flakes;

10.37 pounds of calcium formate;

and 1.04 pounds of magnesium silico fluoride.

Everything is mixed except the aluminum flakes, which are added at the jobsite. In the alternative, aluminum may not be required if the mix is maintained in the truck for a sufficient time period, such as 30 minutes or longer.

The truck travels by a back road and reaches the construction site in 25 minutes while mixing the contents of its drum. It is discharged promptly and fills the emergency need of the customer.

The method of the present invention is universally applicable to expanded concrete mixtures generally; that is, compositions with or without aggregate and concrete with a broad range and content of additives and/or pozzolanic materials.

The method is accordingly applicable to expanded concrete mixtures that include aggregate inclusive of maximum aggregate content mixtures where contiguous aggregate contact is achieved.

As used herein “contiguous contact” of the aggregate component of the concrete mixtures of the present inventions means that all the aggregate pieces are in contact with adjacent and/or overlying and/or underlying pieces, the configuration of each piece permitting. This means that every piece contacts a plurality of adjacent pieces and no aggregate pieces are allowed to float in the matrix.

The detailed description of the invention is directed to the most preferred embodiments of the invention described herein and the invention is not limited to the preferred and/or most preferred embodiments described.

It will of course, be understood that various details can be modified through a wide range without departing from the principals of the invention described in this patent application.

What is claimed is:

1. A method of sequentially using surfactants for producing pre-pour air-filled bubbles during mixing of fresh concrete and of including a selected amount of aluminum in said matrix for producing post-pour hydrogen-filled bubbles, whereby said post-pour bubbles replace a portion of said pre-pour bubbles which are destroyed during casting of said fresh concrete to form cellular concrete.

2. The method of claim 1, wherein said cellular concrete contains sufficient cementitious matrix that the ratio of matrix volume to aggregate volume reduces void volume in said aggregate, after compaction thereof, to approximately zero, whereby said aggregate is in contacting relationship and said matrix maintains said aggregate in position after hardening of said matrix.

3. The method of claim 2, wherein the density of said cellular concrete is within the range of about 45 to about 100 pounds per cubic foot and the compressive strength of said cellular concrete throughout said range is approximately equal to the compressive strength of normal concrete having a density of 160 pound per cubic foot.

4. The method of claim 3, wherein said fresh concrete comprises cementitious materials, fine aggregates, coarse aggregates, fiber, water, and additives.

5. The method of claim 4, wherein said cementitious materials comprise cement and/or at least one substitute as about 26% to about 27% by weight of said fresh concrete.

6. The method of claim 5, wherein said at least one substitute comprises a pozzolanic material.

7. The method of claim 6, wherein said pozzolanic material is selected from the group fly ash, slag, ground glass and mixtures thereof.

8. The method of claim 6, wherein the pozzolanic material is finely ground.

9. The method of claim 6, wherein said at least one substitute comprises up to about 80% by weight of said cementitious materials.

10. The method of claim 6, wherein said at least one substitute comprises up to about 70% by weight of said cementitious materials.

11. The method of claim 9, wherein fine aggregates comprise fine sand, as approximately 11% by weight of said fresh concrete.

12. The method of claim 11, wherein said coarse aggregates comprise expanded shale, expanded clay, pumice, and similar lightweight materials.

13. The method of claim 12, wherein said fiber is about 1% by weight of said fresh concrete, and said water is about 10.5% by weight of said fresh concrete.

14. The method of claim 13, wherein said additives are pre-mixed in powder form and comprise, as pounds per cubic foot of said fresh concrete:
a) surfactant: about 0.04;
b) aluminum flakes: about 0.01;
c) calcium formate: about 0.06; and
d) magnesium silico fluoride: about 0.006.

15. The method of claim 4, wherein said surfactant is dodecyl benzenesulfonic acid.

16. The method of claim 4, wherein said aluminum is in the form of aluminum flakes.

17. The method of claim 4, wherein said fiber is polypropylene fiber.

18. The method of claim 4, wherein said cement is Portland cement types I, II or III.

19. A method for ascertaining the exact amount of a preferred matrix to be added to a mixture of aggregates, thereby ascertaining the optimum value of the volume ratio of cementitious matrix to said aggregates, whereby said aggregates will be in contiguous contact with the interstices between said aggregrates filled with and surround by said matrix, according to the following steps:
a) provide a container of predetermined volume;
b) fill said container to the top thereof with desired amounts of aggregates;
c) gently compact said aggregates and add sufficient additional aggregates to coincide with the top of said container;
d) fill said container to overflowing with water, wait for said aggregates to be saturated with said water, if the water level falls below the plane coinciding to the opening at the top of the container, then add additional water to overflow said container;
e) remove said water from said mold and measure its volume;
f) add said volume of said matrix to said aggregates in said container, thereby forming fresh concrete; and
g) subject said fresh concrete in said container to vibration in order to remove voids and then, if necessary, add additional matrix so that said container is exactly filled to the top of said container.

20. The method of claim 19, wherein the mixture of aggregates comprises a mixture of fine and coarse aggregates.

21. The method of claim 19, wherein the suitability of a fly ash can be evaluated as to:
a) the carbon content thereof;
b) said carbon's porous surface area; and
c) the capacity of said carbon to adsorb the surfactant, by packing said fly ash into said container, adding a matrix thereto, waiting until said carbon has adsorbed a portion of said matrix, and adding sufficient additional matrix so that said mold is exactly filled to the top of said container.

22. A method of making a fiber reinforced lightweight high strength cellular concrete casting having a cured weight of under ninety pounds per cubic foot, which comprises the steps of:
(1) entraining air in a concrete slurry in the presence of a surfactant to form an aerated concrete slurry having a cementitious cellular structure;
(2) casting the aerated concrete of step 1 in admixture with an in situ hydrogen-gas generating composition present in an amount such that hydrogen gas evolution during casting substantially maintains the cementitious cellular structure of the aerated concrete slurry produced in step 1 during the step of casting.

23. A fiber reinforced lightweight high strength cellular concrete casting having a cured weight of under ninety pounds per cubic foot, made by the process of:
(1) entraining air in a concrete slurry in the presence of a surfactant to form an aerated concrete slurry having a cementitious cellular structure;
(2) casting the aerated concrete of step 1 in an admixture with an in situ hydrogen-gas generating composition present in an amount such that hydrogen gas evolution during casting substantially maintains the cementitious cellular structure of the aerated concrete slurry produced in step 1 during the step of casting.
